(19) United States
(12) Patent Application Publication
(10) Pub. No.: US 2019/0050537 A1
(43) Pub. Date: Feb. 14, 2019

(54) PREDICTION AND GENERATION OF HYPOTHESES ON RELEVANT DRUG TARGETS AND MECHANISMS FOR ADVERSE DRUG REACTIONS

(71) Applicant: International Business Machines Corporation, Armonk, NY (US)

(72) Inventors: Heng Luo, Ossining, NY (US); Ping Zhang, White Plains, NY (US); Achille B. Fokoue-Nkoutche, White Plains, NY (US); Jianying Hu, Bronx, NY (US)

(21) Appl. No.: 15/671,898

(22) Filed: Aug. 8, 2017

(51) Int. Cl. G06F 19/00; G06N 99/00

(52) U.S. Cl. CPC G06F 19/345; G06N 99/005

(57) ABSTRACT

A system framework and method for predicting adverse drug reactions (ADRs). Structures represented in three-dimensions were prepared for small drug molecules and unique human proteins and binding scores between them were generated using molecular docking. Machine learning models were developed using the molecular docking features to predict ADRs. Using the machine learning models, it can successfully predict a drug-induced ADR based on drug- target interaction features and known drug-ADR relationships. By further analyzing the binding proteins that are top ranked or closely associated with the ADRs, there may be found possible interpretation of the ADR mechanisms. The machine learning ADR models based on molecular docking features not only assist with ADR prediction for new or existing known drug molecules, but also have the advantage of providing possible explanation or hypothesis for the underlying mechanisms of ADRs.

### FIELD

The present invention relates generally to systems and methods for predicting adverse drug reactions, and particularly a framework for predicting potential adverse drug reactions (ADRs) for drug candidates and undetected ADRs for marketed drugs, and identifying the relevant targets. Further aspects enable use of the framework to assess the mechanisms of actions about certain ADRs.

### BACKGROUND

Machine learning models have been developed to predict adverse drug reactions and improve drug safety. Though some prediction methods are effective, most machine learning models do not provide sufficient, if any, biological explanation for the prediction results, especially information relevant to target binding.

Adverse drug reactions (ADRs) are complicated and can vary from individual to individual. Identification of relevant targets can not only help to understand the mechanisms of ADRs, but also help to focus on potentially causative aspects, such as genetic mutations, thus helping with the improvement of precision medicine.

While computational methods have been developed to predict adverse drug reactions using a variety of features (e.g., chemical structures, binding assays and phenotypical information) and models (e.g., logistical regression, random forest and support vector machine), most of the studies focus on feature variety and model performance instead of hypothesis generation of mechanism explanation.

### SUMMARY

A system, method and computer program product for predicting possible ADRs for a new or candidate drug by requiring only the structural input of a drug molecule. Additionally, the relevant binding targets that may play a key role in causing such ADRs can be identified/highlighted.

According to one embodiment, there is provided a method to automatically predict an adverse drug reaction for a new drug or predict an undetected adverse drug reaction for a currently marketed drug.

The method comprises: receiving, at a processor, data regarding a molecular structure of a drug; computing for the drug, using the processor, a plurality of drug-target interaction features, each drug-target interaction feature between the drug molecular structure and each of a plurality of unique, high-resolution target protein structures; running, at the processor, one or more classifier models associated with a corresponding one or more known adverse drug reaction (ADR); predicting, using each the classifier model, one or more ADRs based on the drug-target interaction features involving the drug and known drug-ADR relationships; and generating, by the processor, an output indicating the predicted one or more ADRs.

In a further embodiment, there is provided a system to automatically predict an adverse drug reaction for a drug. The system comprises: at least one memory storage device; and one or more hardware processors operatively connected to the at least one memory storage device, the one or more hardware processors configured to: receive data regarding a molecular structure of a drug; compute, for the drug, a plurality of drug-target interaction features, each drug-target interaction feature being between the drug molecular structure and each of a plurality of unique, high-resolution target protein structures; run one or more classifier models associated with a corresponding one or more known adverse drug reaction (ADR); predict, using each the classifier model, one or more ADRs based on the drug-target interaction features involving the drug and known drug-ADR relationships; and generate an output indicating the predicted one or more ADRs.

In a further aspect, there is provided a computer program product for performing operations. The computer program product includes a storage medium readable by a processing circuit and storing instructions run by the processing circuit for running a method. The method is the same as listed above.

### BRIEF DESCRIPTION OF THE SEVERAL VIEWS OF THE DRAWINGS

FIG. 1 generally depicts a system framework 100 implementing methods for predicting hypotheses on relevant drug targets and mechanisms for ADRs in one embodiment;

FIG. 2A is an example visualization of such a feature data matrix that includes the drugs as rows, the target proteins as columns, and the computed binding scores as features;

FIG. 2B is an example visualization of such a binary label matrix that includes drugs as rows and ADR labels as columns;

FIG. 3 depicts conceptually, the method for generally predicting an ADR and determining underlying ADR mechanism for an unknown or new drug structure according to one embodiment;

FIG. 4 shows an exemplary method for determining a target binding prediction and ADR for a new or existing drug molecule according to one embodiment;

FIG. 5 shows an exemplary computer system interface display depicting the input of an unknown or new drug molecule for processing according to the methods herein;

FIG. 6A shows a generated list of the top three (3) drugs that are predicted with their respective confidences for a specific example ADR dermatitis acneiform;

FIG. 6B shows a table indicating the top predicted binding proteins for Mometasone;

FIG. 7 shows further analysis steps 700 that may be used to generate a hypothesis for the cause of the ADR Dermatitis acneiform of a first case study example;

FIG. 8 depicts an example of the top ranked proteins from which it may determined that a Glucocorticoid receptor is the second most contributing feature according to the developed ADR model;

FIG. 9 shows further analysis steps that may be used to generate a hypothesis for the cause of the ADR cataract subcapsular of a second case study example;

FIG. 10 shows for an example first case study, the predicted binding conformations between a drug Mometasone and the orphan nuclear receptor gamma (RORγt) ligand-binding domain of a known protein;

FIG. 11 schematically shows an exemplary computer system/computing device which is applicable to implement the embodiments of the present invention; and

FIG. 12 illustrates yet another exemplary system in accordance with the present invention.

### DETAILED DESCRIPTION

A system, method and computer program product for predicting adverse drug reactions (ADRs) from structural input of drug molecule. The systems and methods further generate hypotheses by highlighting the relevant binding targets that may play a key role in causing ADRs. More specifically, a system framework is provided for implementing methods for automatically generating interaction scores associated with the 3D structure of the drug and conforming such scores from a structural library.

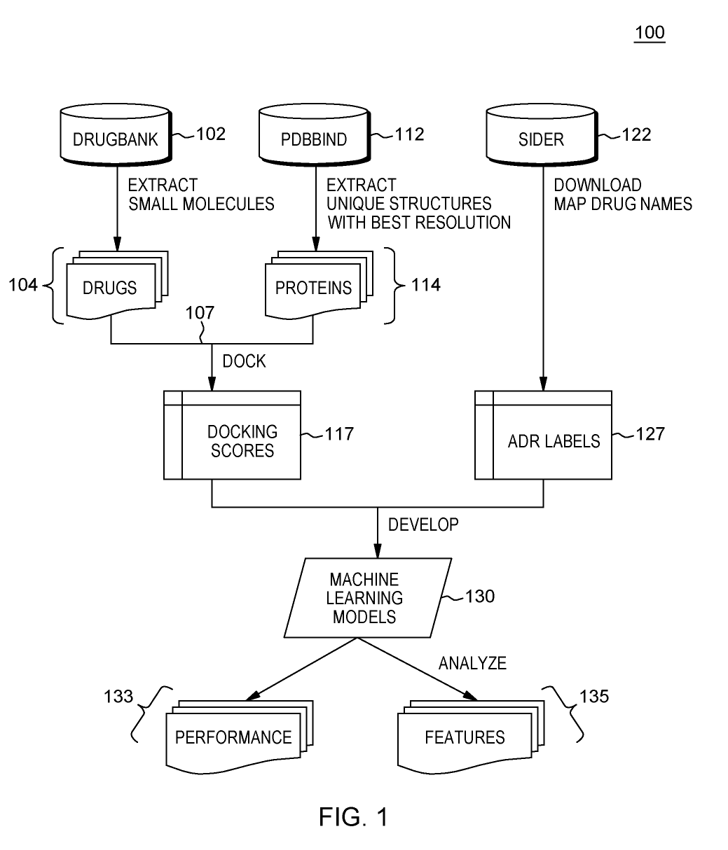

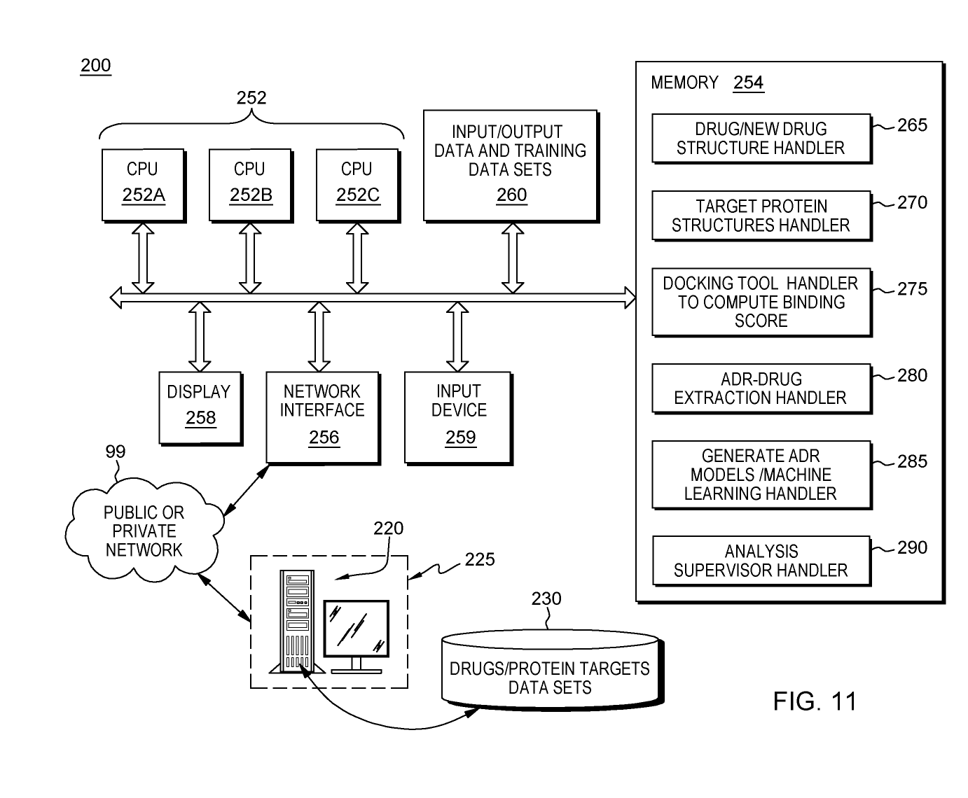

FIG. 1 shows an overview of a method 100 run by a computer system for predicting ADRs from data representing a structure of a new drug compound. Initially, a computer system, such as the system shown in FIG. 11, first obtains data representing drug molecules and data representing a plurality of protein structures and runs a molecular docking program for generating a drug-target interaction feature, i.e., a molecular binding score. In one embodiment, the method includes extracting 2-D or 3-D structures of drug molecules from a database such as the commercially available DrugBank Version 5.0 database resource 102 (e.g., available at www.drugbank.ca). As known, the DrugBank resource 102 combines detailed drug (i.e. chemical, pharmacological and pharmaceutical) data with comprehensive drug target (i.e. sequence, structure, and pathway). In one embodiment, to obtain a drug set or drug library 104, the computer system harvests the SMILES (Simplified Molecular-Input Line-Entry System) notation used for encoding molecular structures of all the small molecules in DrugBank 5.0.

In a further embodiment, for the drug molecules in the drug set 104, the computer system may access tools for generating associated 3D molecular structures based on an input chemical formula or drawing representing a 2-D molecule, e.g., using the “molconvert” command line via an interface generated by program tool “MolConverter” available in Marvin Beans (e.g., available from ChemAxon Marvin Beans 6.0.1). In one embodiment, the Marvin Beans is an application and API for chemical sketching and visualization and a Molconverter tool for converting files between 2-D and 3-D various file formats, e.g., molecule file formats, graphics formats etc.

Further, in one embodiment, for the 3-D drug molecules in the drug set 104, the system may first remove the drug molecules that do not have rotatable bonds (e.g., such as calcium acetate) or that are too large (having a molecular weight >1200, e.g., such as cisatracurium besylate) since they may not generate meaningful docking scores, e.g., too large to fit into protein pockets.

As further shown in FIG. 1, the computer system further obtains data representing the plurality of protein structures. For purposes of discussion, human proteins are used but the invention may be adapted for other animal protein types. For the protein set, the system harvests the general collection of the PDBBind database resource 112 (e.g., available at www.pdbbind.org.cn) or like protein data bank, which is a curated source of crystal structures. Human proteins 114 were selected and only one unique structure for each protein with the best resolution were selected. Via a computer system interface, a user may select a particular protein, e.g., by entering via an interface to the PDBBind database resource 112: according to a resolution, a PD, a unique selection, and a PDBBind criteria.

In one embodiment, extracted from the PDBBind database 112, are data representing unique human protein targets. The target proteins are selected from the PDBBind database 112 according to selected criteria: (1) High-quality: all the protein structures extracted are to have high resolutions on the order of 1.98±0.47 Å; (2) Targetable: the structures have experimental ligand binding data available; (3) Unique human proteins: the structures represent unique human proteins, i.e., for one protein, selecting the one of the many possible crystal structures available that have the highest resolution; and (4) Well-defined binding pockets: the structures have embedded ligands to define binding pockets.

After the selection and extracting of the drug molecules set 104, and unique target proteins set 114, the method prepares structure files using an automated docking tools such as AutoDock Tools 1.5.6 (e.g., available at autodock.scripps.edu). In one embodiment, Gasteiger charges are added to both the drug and target structures using the preparation scripts of AutoDock Tools. As known, the AutoDock Tools are software programs configured to prepare files that are needed to predict how small molecules, such as substrates or drug candidates, bind to a receptor of a known 3D (e.g., target protein) structure. In one embodiment, the binding pockets of the proteins are centered at the original embedded ligands, with a fixed size of 25×25×25 Å³ to reduce pocket-based variation.

Continuing in the method 100 of FIG. 1, the method at 107 includes docking each of the drug molecules from set 104 towards each of the protein structures of protein set 114 using AutoDock Vina 1.1.2 research tool (e.g., available at vina.scripps.edu) with a fixed random seed and other default parameters. As known, AutoDock Vina is a software program for performing molecular docking that provides highly accurate binding mode predictions, i.e., computing molecular docking scores 107 (or molecular binding scores) and conformations between them. In one embodiment, for its input and output, AutoDock Vina uses a same PDBQT (Protein Data Bank, Partial Charge (Q), & Atom Type (T)) format) molecular structure file format used by AutoDock tools and AutoDock 4. All that is required is the structures of the molecules being docked and the specification of the search space including the binding site. The lowest docking scores and corresponding binding conformations were extracted and stored as drug-target interaction feature set 117.

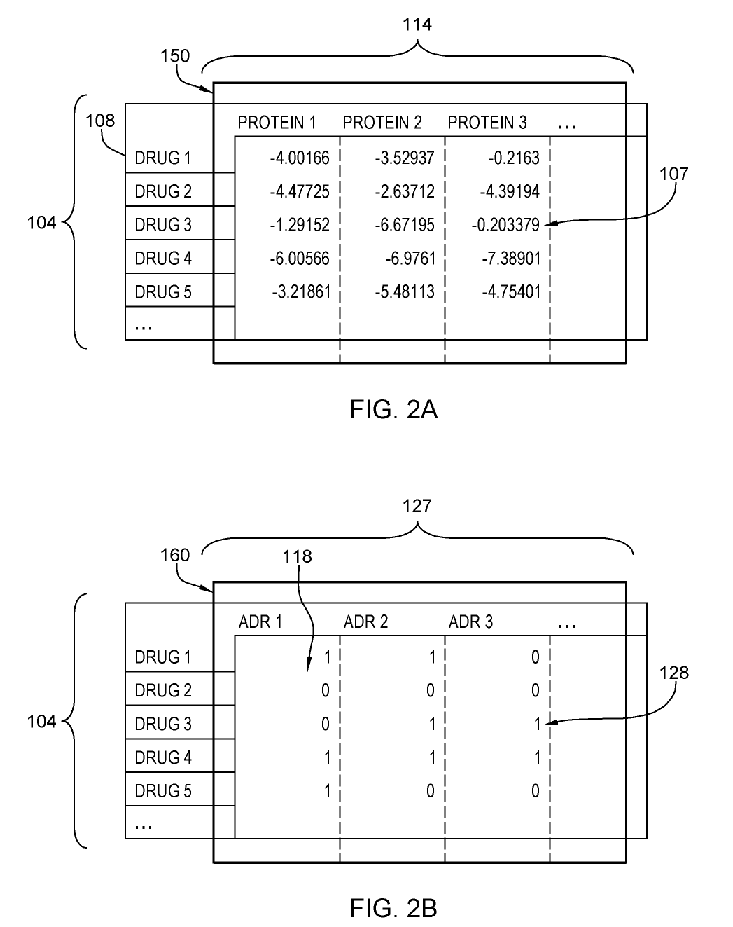

Based on the method steps of FIG. 1 leading up to the generation of docking scores, in one embodiment, there is harvested a feature data matrix. FIG. 2A is an example visualization of such a feature data matrix 150 (a 2-D matrix) that includes the drugs 104 as rows, the target proteins 114 as columns, and the individual computed binding scores 107 of interacting drugs/target proteins as features forming the drug-target interaction feature set 117.

Returning to FIG. 1, in parallel (concurrent) or subsequent processes, the method 100 performs harvesting data from the SIDER (Side Effect Resource) database 122, such as the SIDER database Version 4.1 which contains adverse drug reactions (ADR) information extracted from drug labels, as a ground truth for a set of ADR labels 127 (and which can be found at http://sideeffects.embl.de). In one embodiment, the method performs a mapping of the drug names from the SIDER database to a DrugBank ID using DrugBank synonyms. Thus, the existing drug-ADR relationship known from the SIDER database is harvested.

In one embodiment, based on the method steps of FIG. 1 leading up to the generation of ADR labels 127, there is harvested data representing a second binary label matrix. FIG. 2B is an example visualization of such a binary label matrix 160 that includes drugs 104 as rows and ADR labels 127 as columns. For each ADR, if a drug is known to cause it, the drug-ADR pair label 128 is marked as binary value, e.g., “1” (positive), meaning that the drug causes an ADR; otherwise, the drug-ADR pair label 128 is marked as “0” (negative) binary value meaning that there is no relationship between the drug and the ADR.

In one embodiment, the method may first include a filtering step to filter the ADRs that contain less than a pre-determined amount of positive drugs, e.g., five positive drugs, since they have too few positive samples.

Returning to FIG. 1, in subsequent processes, the computer-implemented method includes developing and evaluating of machine learning models 130 that can be used to predict ADRs for a new drug based on the drug-target interaction features and known drug-ADR relationships. That is, treating the first harvested feature matrix 150 and second harvested binary label matrix 160 (of FIGS. 2A, 2B) as a training data set, the method 100 defines a machine learning problem: Y=f(X) such that, features (Xs): are docking scores and Labels (Ys): cause an ADR or not. For each ADR, there is developed a corresponding prediction model, and in particular, one logistic regression classifier with L2 regularization is developed for each ADR using the protein binding scores as features. In one embodiment, the classifiers may be implemented in Python 2.7.12 (e.g., Anaconda® 4.1.1 software) with sklearn Version 0.17.1 (Anaconda® is a registered trademark of Continuum Analytics Inc. Austin Tex. 78701).

In one embodiment, one logistic classifier model is generated for each ADR. In one embodiment, training an ADR model includes, for a specific ADR, the obtaining one ADR column at a time, e.g., column 118 in FIG. 2B, having the binary values representing the labels (Ys); and obtaining the entire feature matrix f(X) such as the drug interaction feature matrix 150 shown in FIG. 2A. To build the classifier, for each ADR, there is input data corresponding to the one label column 118 (FIG. 2B), and input each for each drug sample 108 (of one or more rows 104) each of the corresponding multiple features (molecular binding scores) in columns, e.g., columns 114 in FIG. 2A. there are multiple drug samples as rows 104.

In one embodiment, for a specific ADR model, these inputs are received in one logistic regression function such as:

$$f ( x ) = \frac{1}{1 + {e}^{- ( a + {b}_{1} {x}_{1} + {b}_{2} {x}_{2} + ⋯ + {b}_{600} {x}_{600} )}}$$

Given drug x, the molecular docking scores towards 600 proteins are a vector of (x₁, x₂, . . . , x₆₀₀). The coefficients (b₁, b₂, . . . , b₆₀₀) along with the value for constant α were obtained during the model training process. The methods include calculating f(x) as the predicted confidence score (range: 0% to 100%) that drug x may cause this specific ADR.

In one embodiment, the sklearn package in Anaconda® Python may be implemented on the computer system to develop the logistic regression model and in one embodiment, the coefficients are determined via minimizing a cost function (which is the aggregated difference between predictions and actual values). Use of L2 regularization may yield coefficients with best prediction performance. The Scikit-learn software machine learning library for the Python programming language may also be used to develop the ADR model.

In one embodiment, the coefficients calculated in a logistic regression ADR model build using the machine learning mathematical techniques are subject to relevant target analysis to understand ADR mechanism.

In one embodiment, to select the best parameters for a model, different combinations of regularization types (L1 and L2) and parameters (C=0.001, 0.01, 0.1, 1, 10, 100 and 1000) during 10-fold cross-validations may be explored and the best parameters may be selected based on a best area under the receiver operating characteristic curve (AUROC). To demonstrate the ADR prediction performance of molecular docking, seven different types of structural fingerprints were generated for the drugs in the training set for feature comparison. The seven structural fingerprints are E-state, Extended Connectivity Fingerprint (ECFP)-6, Functional-Class Fingerprints (FCFP)-6, FP4, Klekota-Roth method, MACCS and PubChem structural descriptors (called E-state, ECFP6, FCFP6, FP4, KR, MACCS and PubChem, respectively). After comparing the prediction performance of molecular docking against these structural fingerprints via 10-fold cross-validations on both AUROC and area under the precision-recall curve (AUPR) values, the final models 130 were developed based on molecular docking features with the optimal parameters.

It should be understood that there are different types of prediction models that can be developed to predict ADRs. For example, while there is built a separate model for each ADR as described, there may also be developed only one model which can predict for all ADRs. For this alternative approach, there is a need to harvest features for ADRs, such that each row in the training set represents a drug-ADR pair, and it contains both the drug and ADR features. The label for such row is either positive (represents known drug-ADR association) or negative (represents unknown drug-ADR association).

As further shown in FIG. 1 at 133, the developed models may then be used to make ADR predictions for the drugs that do not yet exist in the training set. Further, at 135, by analyzing the protein binding features that are associated with the ADR predictions, e.g., in terms of both top-ranking docking scores and corrections, the possible mechanisms for the ADRs may be determined.

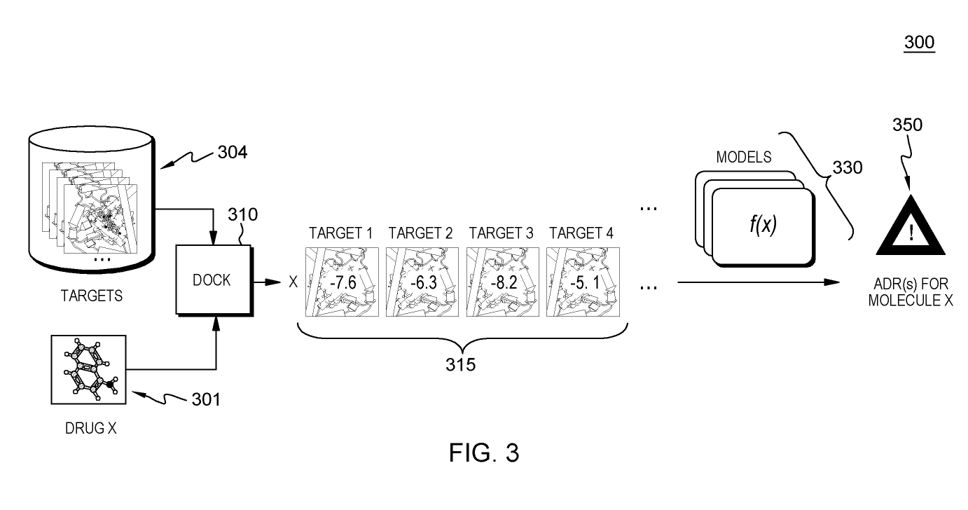

FIG. 3 depicts conceptually, the method 300 for generally predicting an ADR and determining underlying ADR mechanism for an unknown or new drug structure 301 (e.g., Drug X) input to the system according to one embodiment. After building of the training set data including the generation of the drug interaction matrix (e.g., such as shown in FIG. 2A) and the ADR label matrix (e.g., such as shown in FIG. 2B), and after developing each ADR machine learning models using the logistic regression classifier described above, the method to determine an ADR of a new drug is shown in FIG. 3. Initially, the method includes: obtaining a molecular structure for a new/unknown Drug X which may include a physical 3-D structure 301 of the new drug being tested. Then, the new drug structure 301 is input to the AutoDock program or like docking tool 310, e.g., AutoDock Vina, where the molecular binding score of the new drug is obtained for each of the plurality of unique target proteins 304. As a result of the docking, target molecular binding scores (interaction scores) are obtained for each target protein interaction to result in a vector 315 of docking scores for the new drug x against each target protein. The targets may then be ranked by their interaction scores towards the Drug X to indicate which target protein binds to the new drug the best. Additionally, there may be obtained conformations between Drug X and library targets.

Then, interaction results are used to predict ADRs via the machine learning models f(x). Additionally, feature analysis may be implemented to understand the underlying mechanisms of the ADRs.

Thus, as shown in FIG. 3, the built ADR prediction models f(x) 330 are then applied to the vector 315 of docking scores relating to each target (which may be ranked). That is, based on each interaction score between the Drug X and the library targets, the model is applied predict a potential ADR 350 for Drug X based on the interaction scores.

In one embodiment, the ADRs are ranked by confidence scores. For example, the top binding targets for Drug X may be used to study the mechanisms underlying the drug-ADR relationship. See, for example, a first case study Example 1 herein below.

Alternatively, the top relevant targets for the ADRs may be identified via model-based feature/coefficient analysis to understand the mechanisms of the ADRs. See, for example, a second case study Example 2 herein below.

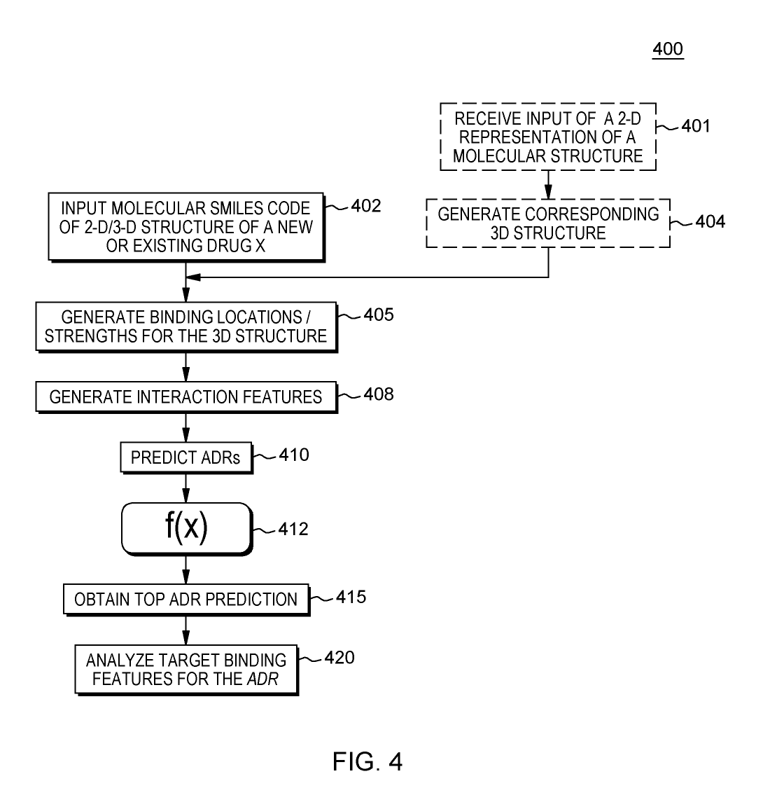

FIG. 4 shows an exemplary method 400 for determining a target binding prediction and ADR for a new (or existing) drug molecule, e.g., a drug X that does not exist in the training set, based on the results of the interaction scores and the determining of the mechanisms underlying the ADR.

In FIG. 4, at 402, in a first embodiment, there is first received a symbolic data representation of a 3-D molecular structure for Drug X. For an existing or known drug structure, there may be obtained a molecular SMILES code representation for the new Drug X which is input to the computer system at 402.

In an alternate embodiment, as shown in FIG. 4, at 401, there may be first received as input into the system, data representing a user-generated 2-D molecular or chemical formula of a new (candidate) drug. Once received into the system, as shown at 404, the system invokes a computer-implemented program or tool for accessing a molecular conversion tool for generating a corresponding 3-D molecular structure of the new (candidate) drug formula. Such a tool may include Molconverter command line program tool available in Marvin Beans (e.g., available from ChemAxon Marvin Beans 6.0.1).

Whether obtained in a first instance by selecting and inputting a known drug formula from a pre-existing list and obtaining a corresponding SMILES code representation as described at 402 in FIG. 4, or by first receiving a user-generated 1-D string or 2-D structural representation of the Drug X and converting it to a corresponding 3-D molecular structure representation as shown at 404 in FIG. 4A, then, as shown at 405, FIG. 4, there is determined the binding locations and zones within the 3D structure. Using molecular docking tools, it may be predicted, with a substantial degree of accuracy, the conformation of the small-molecule ligands of the 3-D structure of the new drug X within the appropriate target binding site of the target protein structures. This may be performed by implementing a program such as AutoDock. Using this data for the input drug formula, the system further generates the interaction features with the Target proteins, i.e., obtain the molecular binding scores and confirmations towards each of the library Target proteins. In addition, there is performed at 405, the ranking and visualization of the Drug X-Target interactions. Then, in FIG. 4, at 410, the method runs the machine learned ADR models 412 to predict and rank ADRs for the new Drug X. In this step, there may be generated an output confidence score indicating a likelihood that the input drug (e.g., new Drug X) causes a drug-protein interaction that is associated with the ADR. Then at 415, further analysis is conducted to determine the top ADR predictions, and determine at 420, a possible cause or interpretation of the new drug. The system may then generate outputs including: the predicted binding Targets including both binding scores and conformations for Drug X; the predicted ADRs for Drug X, and the Target proteins that are relevant to the ADRs.

### Example Case Study 1

In a first example case study, it was determined that the drug Mometasone induces dermatitis acneiform an ADR. Thus, using the exemplary method 400 of FIG. 4, there is first input to the computer system at the molecular SMILES code for Mometasone. Then, at 405, there is generated the interaction features, i.e., the molecular binding scores, with the target proteins of the extracted library.

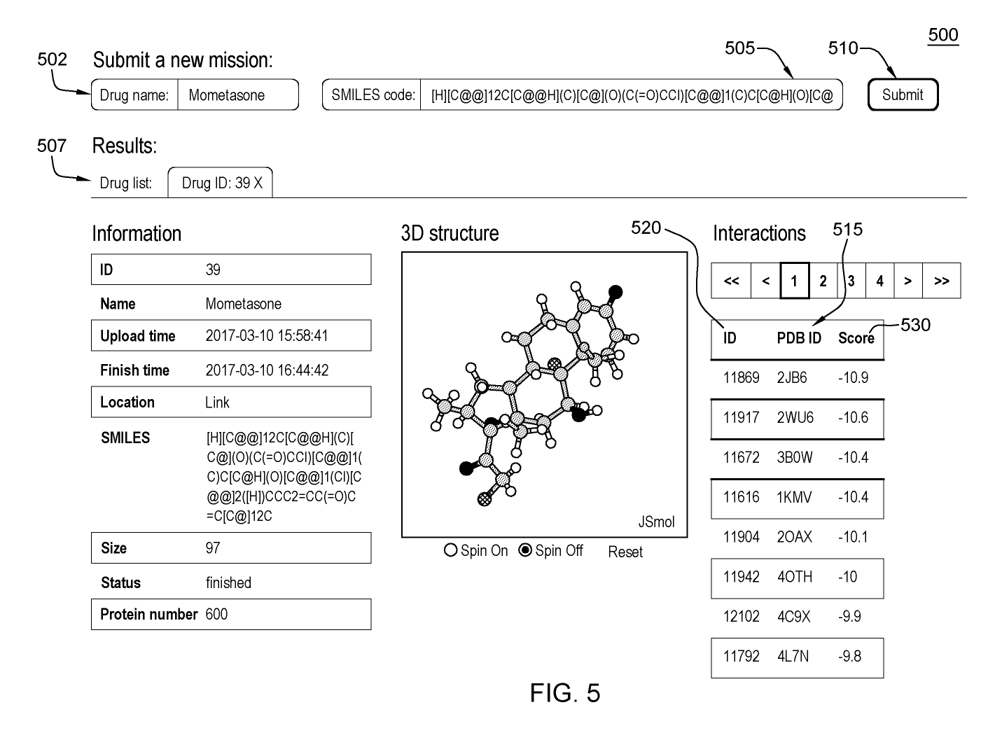

FIG. 5 shows an exemplary computer system interface display 500 depicting the input of an unknown or new drug for processing according to the methods herein. For illustrative purposes, the first example drug 502 (e.g., Mometasone) along with its corresponding SMILES obtained from DrugBank are input 505. In one embodiment, a drug for input may be selected via a drug list displayed in response to selecting the “Drug list” tag 507 via the user interface. In a further embodiment, a user may enter a 1-D string or 2-D structural representation or rendering of a new chemical formula associated with a potential new drug into the system and by invoking an application programming interface access a computer-implemented application providing tool that construct an optimized 3-D molecular object from the 1-D or 2-D renderings of the molecular structure entered. In either embodiment, after inputting a 3-D structure of the new drug (e.g., a 1-D rendering of the drug Mometasone at 505), the existing or new drug formula is input to the AutoDock Vina program via selection of a “submission” interface button 510. The AutoDock Vina program employs conformational search algorithms and employs functions that generates the interactions 515, the quantitative predictions of binding energetics, of the new drug 502 with all of the target proteins in the set. In one example embodiment, there are 600 target proteins that an interaction score is generated for, and each drug-target protein interaction score may be displayed. The drugs 520 are listed with a corresponding protein identifiers (PDBID) 515, and their corresponding interaction scores 530 generated by the AutoDock Vina program. In one embodiment, these scores are ranked according to their binding scores 530.

Then, as described at step 410 of FIG. 4, the method runs the ADR models 412 to predict an ADR for the new or existing drug, e.g., Mometasone.

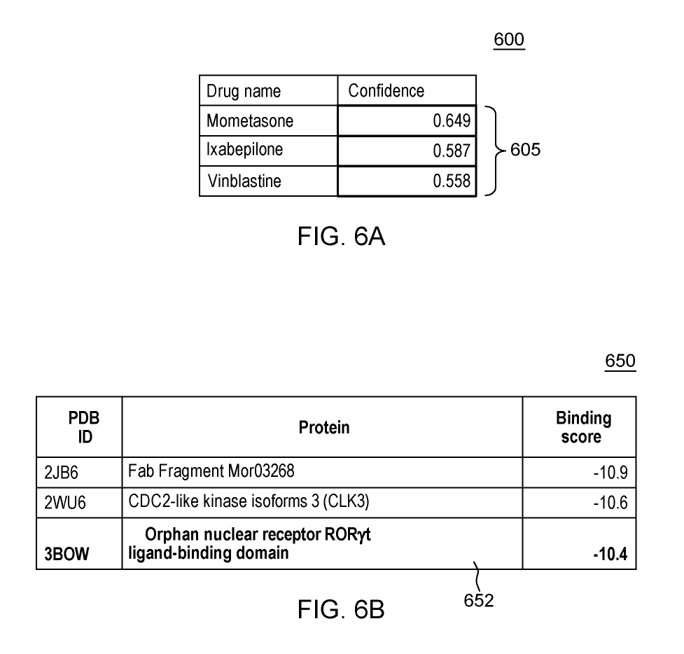

In the first illustrative example, as an output of running each ADR model against the interaction scores 530 for each input drug, there is generated a confidence score that the drug will provide a drug-protein interaction that is associated with the current ADR. As shown in the chart 600 of FIG. 6A there is generated a list of the top three (3) drugs that are predicted with their respective confidences 605 for the ADR dermatitis acneiform.

As known, Dermatitis acneiform (Unified Medical Language System Concept ID: C0234708) is acne-like cutaneous eruptions. As shown in FIG. 6A, the prediction results from running the ADR model for the ADR dermatitis acneiform showed that Mometasone (DrugBank ID: DB00764) was the highest-ranked drug in the test set to cause this ADR with a 0.649 confidence. It has been reported that acneiform eruption is a local adverse effect caused by Mometasone use, which validates the prediction.

To understand the potential mechanisms of this ADR, there may be conducted a Target binding analysis for drug X and an ADR-specific feature analysis. In one embodiment, the method accesses binding scores for the new drug against all target proteins. For this first case study example, processes are invoked for determining the top binding proteins for Mometasone and ranking them by their binding scores. FIG. 6B shows a table 650 indicating the top predicted binding proteins for Mometasone. The orphan nuclear receptor gamma (RORγt) ligand-binding domain (Protein Data Bank ID, or PDB ID: 3B0W) was predicted to be the top 3^{rd} binding target 652 for Mometasone with a binding score of −10.4 as shown in FIG. 6B.

FIG. 10 shows for the example first case study, a visualization of the predicted binding conformations 1000 between the Mometasone drug 1001 and the orphan nuclear receptor gamma (RORγt) ligand-binding domain 1010 (e.g., PDB ID: 3B0W). In FIG. 10, there is shown three-dimensional structure of the ligand 1001 in a three-dimensional structure of receptor 1010 showing the ligand docked into the binding cavity 1012 of the receptor from which the accurate prediction of the interaction energy associated with each of the predicted binding conformations is determined. The “thin sticked” protein residues 1007 of the protein target 1010 are shown within the binding cavity 1012 of the protein target 1010 and have close interaction with the ligand 1001.

In one embodiment, to avoid this ADR interaction, there may be developed a drug modification or a new drug developed to minimize or avoid the binding with the 3B0W protein. Alternatively, the existing drug structure may be re-designed or modified to minimize or avoid the binding with the 3B0W protein. Such modifications include those known in the art, including, without limitation, altering ligand length, size and/or shape, altering spatial configuration, polarity and hydrogen bonding aspects, e.g., adding a heteroatom (oxygen, nitrogen, etc.) or groups that effect hydrogen bonding to avoid interaction with a protein determined as the underlying cause of the ADR.

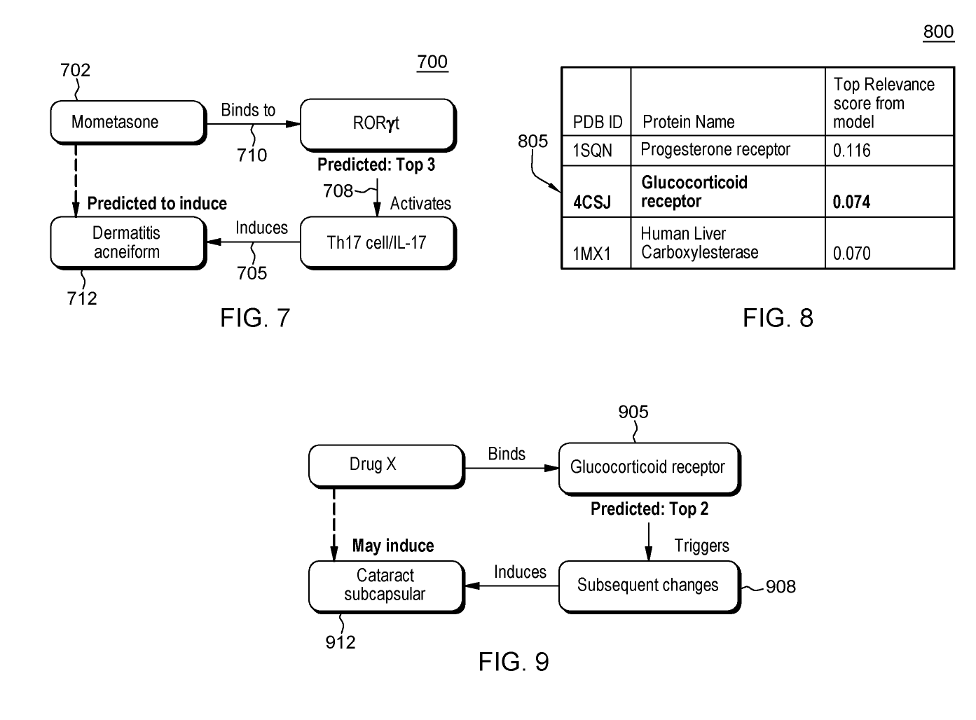

As mentioned above with respect to FIG. 1, in further analysis steps 135, there may be generated a hypothesis for the cause of the ADR. FIG. 7 shows further analysis steps 700 that may be used to generate a hypothesis for the cause of the ADR Dermatitis acneiform of the first case study example. In studies, it has been found that IL-17 expressing cells and Th17-related signaling exist in or induce acneiform lesions 705. At 708, it is shown that RORγt is needed for Th17 cell differentiation and IL-17 production. It may be hypothesized at 710 that through binding to RORγt and thus affecting the Th17/IL-17 level, the Mometasone drug 702 induces the occurrence of dermatitis acneiform 712.

### Example Case Study 2

In a second example case study, the computer system performs a model based feature analysis, i.e., a coefficient analysis, including analyzing the feature coefficients of the ADR model and ranking the target according to the coefficients to understand the mechanisms relevant to the ADR.

In the second example case study, there may be determined a drug that may induce cataract subcapsular—an ADR. Thus, in accordance with a further analysis step 133 of FIG. 1, the docking score vector from each of the 600 protein features (FIG. 2A) are analyzed towards the label vector (FIG. 2B) of a cataract subcapsular ADR to evaluate their individual performance.

As a result of the analysis, the methods determine the top protein features related to a subject ADR as weighted by the corresponding ADR model. FIG. 3 shows an example table 800 indicating the top three (3) protein features related to the cataract subcapsular ADR according to the absolute value of their logistic regression coefficients for that ADR model. Thus, in the second example case study, there is obtained the absolute values of the coefficient (b₁, b₂, . . . , b₆₀₀) to indicate the weight contributions of corresponding protein target proteins 1-600 towards the ADR prediction (e.g., cataract subcapsular). A larger absolute value indicates a bigger contribution to the model.

In the analysis shown in table 800 of FIG. 8, it is determined that a Glucocorticoid receptor 805 is the second most contributing feature according to the developed ADR model.

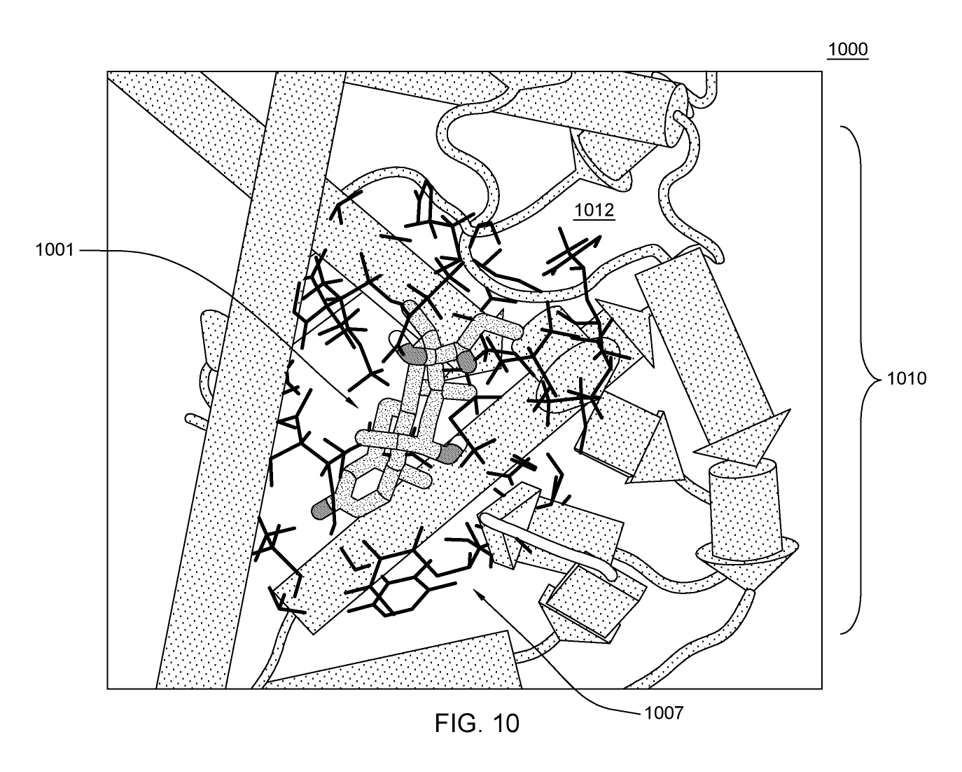

FIG. 9 shows further analysis steps 900 that may be used to generate a hypothesis for the cause of the ADR cataract subcapsular 912 of the second case study example. To understand the potential mechanisms of this ADR, it was reported in studies that steroid-induced posterior subcapsular cataracts associate only with steroids possessing glucocorticoid activity, where glucocorticoid receptor activation 905 and its subsequent changes (cell proliferation and suppressed differentiation, etc.) 908 play a key role. Thus, it would be determined that a drug (e.g., a new Drug X) binding towards glucocorticoid receptor may be important to cataract subcapsular occurrence.

Thus, from this feature-based analysis, it is possible to find protein targets that are associated with ADRs, thus generating hypothesis that help to explore and understand the mechanisms of ADRs.

From the above case studies, the methods can not only predict ADRs for drug molecules, but also provide possible mechanism explanations via the binding targets. Since ADRs are complicated and differ from individual to individual, such explanation could potentially provide clues for toxicology researchers to generate hypothesis and help with the design for wet-lab experiments about ADR mechanisms, thus improving the safety evaluation of drugs. As the methods only require the structural information of the drug molecules to predict ADRs, it is feasible to use it in the early drug development stage when other types of information of the drug candidates are limited.

FIG. 11 schematically shows an exemplary computer system/computing device which is applicable to implement the embodiments of the present invention;

Referring now to FIG. 11, there is depicted a computer system framework 200 running methods to predict and generate hypotheses on relevant drug targets and mechanisms for adverse drug reactions. In some aspects, system 200 may include a computing device, a mobile device, or a server. In some aspects, computing device 200 may include, for example, personal computers, laptops, tablets, smart devices, smart phones, smart wearable devices, smart watches, or any other similar computing device.

Computing system 200 includes at least one processor 252, a memory 254, e.g., for storing an operating system and/or program instructions, a network interface 256, a display device 258, an input device 259, and any other features common to a computing device. In some aspects, computing system 200 may, for example, be any computing device that is configured to communicate with a database 230 web-site 225 or web- or cloud-based server 220 over a public or private communications network 99. Further, shown as part of system 200 is a further memory 260 for temporarily storing extracted Drug-Target interaction features and drug-ADR information, e.g., used for building the ADR model(s). For example, in one embodiment, further memory 260 may provide the structural library including a database of identified drugs and human protein targets and their interaction profiles calculated via molecular docking.

In one embodiment, as shown in FIG. 11, a device memory 254 stores program modules providing the system with the abilities to predict and generate hypotheses on relevant drug targets and mechanisms for adverse drug reactions. For example, a drug/new drug structure handler module 265 is provided with computer readable instructions, data structures, program components and application interfaces for interacting with the Drugbank database V 5.0 web-site for processing and handling of detailed drug (i.e., chemical, pharmacological and pharmaceutical) data. A target protein handler module 270 is provided with computer readable instructions, data structures, program components and application interfaces for interacting with the PDBBind 112 database web-site for selecting and processing of target proteins. A docking tool handler module 275 is provided with computer readable instructions, data structures, program components and application interfaces for interacting with the AutoDock Vina docking program to generate the molecular binding scores between drugs and the selected target proteins. An ADR-drug extraction handler module 280 is provided with computer readable instructions, data structures, program components and application interfaces for interacting with the SIDER database for obtaining the ADR information extracted from specific drug labels. A machine learning tool handler module 285 is provided with computer readable instructions, data structures, program components and application interfaces for interacting with a supervised machine learning program to generate the logistic regression ADR models. A further program module is an analysis supervisor handler module 290 that is provided with computer readable instructions, data structures, program components and application interfaces for conducting the ADR prediction analysis and hypothesis generation for a new drug according to the steps of FIG. 4.

In FIG. 11, processors 252 may include, for example, a microcontroller, Field Programmable Gate Array (FPGA), or any other processor that is configured to perform various operations. Processor 252 may be configured to execute instructions according to the methods of FIGS. 1 and 4. These instructions may be stored, for example, in memory 254.

In one embodiment, the computer system 200 is a machine implementing multiple processors. As the molecular docking process is a most time consuming process, i.e., each time when a new drug is to be processed, it needs to dock to 600 proteins, then multiple control processor units, e.g., CPUs 252A, 252B, 252C can speed this up by parallel computing the docking process. For example, instead of molecular docking 600 proteins one by one, a 50-core machine can do 50 dockings at a time. In one embodiment, computer system 200 may be a multi-core machine, whereby the more cores had, the faster is the computation. For ADR model development, multi-cores would help to speed up the parameter testing. For example, if it is desired to test 10 sets of parameters, a 10-core machine can do it in one batch.

Memory 254 may include, for example, non-transitory computer readable media in the form of volatile memory, such as random access memory (RAM) and/or cache memory or others. Memory 254 may include, for example, other removable/non-removable, volatile/non-volatile storage media. By way of non-limiting examples only, memory 254 may include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Network interface 256 is configured to transmit and receive data or information to and from a database web-site server 220, e.g., via wired or wireless connections. For example, network interface 256 may utilize wireless technologies and communication protocols such as Bluetooth®, WWI (e.g., 802.11a/b/g/n), cellular networks (e.g., CDMA, GSM, M2M, and 3G/4G/4G LTE), near-field communications systems, satellite communications, via a local area network (LAN), via a wide area network (WAN), or any other form of communication that allows computing device 200 to transmit information to or receive information from the server 220, e.g., to select particular Target protein structures data or specify small molecule drug structure data from respective databases.

Display device 258 may include, for example, a computer monitor, television, smart television, a display screen integrated into a personal computing device such as, for example, laptops, smart phones, smart watches, virtual reality headsets, smart wearable devices, or any other mechanism for displaying information to a user. In some aspects, display 258 may include a liquid crystal display (LCD), an e-paper/e-ink display, an organic LED (OLED) display, or other similar display technologies. In some aspects, display 258 may be touch-sensitive and may also function as an input device.

Input device 259 may include, for example, a keyboard, a mouse, a touch-sensitive display, a keypad, a microphone, or other similar input devices or any other input devices that may be used alone or together to provide a user with the capability to interact with the computing device 200.

In an early drug development stage, pharmaceutical companies can use this system framework 200 to predict potential ADRs for drug candidates and identify the relevant targets. Therefore, they can choose other candidates that are predicted to be safer or less likely to bind with the risky targets to avoid ADRs. Further, in a post-market stage, pharmaceutical companies can use this system framework 200 to identify the mechanisms of actions about certain ADRs. By studying the relevant targets by the framework, they may find genetic mutations that may alter the susceptibility to ADRs regarding these targets. Therefore, they can advise patients with the specific genetic mutations to adjust the usage of the risky drugs (aka. precision medicine).

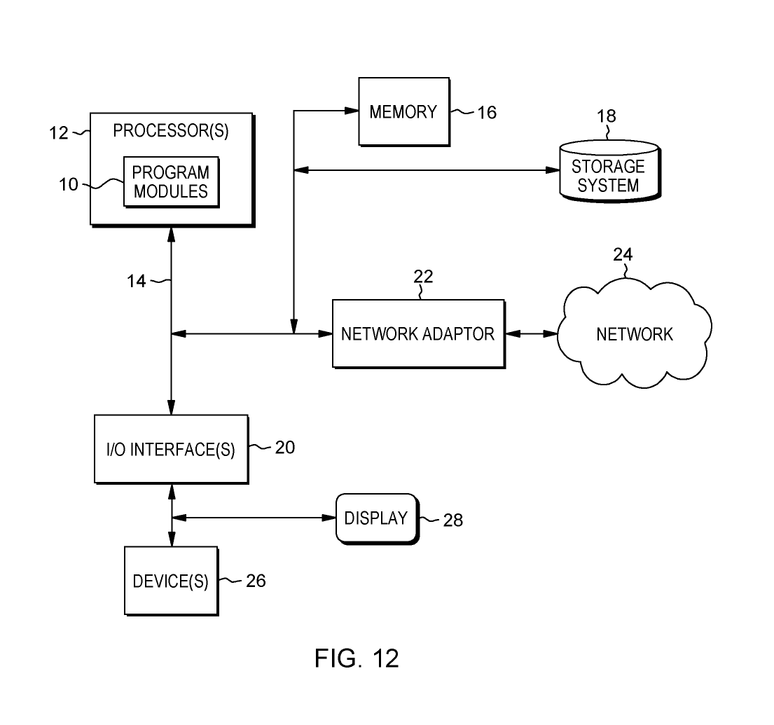

FIG. 12 illustrates an example computing system in accordance with the present invention. It is to be understood that the computer system depicted is only one example of a suitable processing system and is not intended to suggest any limitation as to the scope of use or functionality of embodiments of the present invention. For example, the system shown may be operational with numerous other general-purpose or special-purpose computing system environments or configurations. Examples of well-known computing systems, environments, and/or configurations that may be suitable for use with the system shown in FIG. 12 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

In some embodiments, the computer system may be described in the general context of computer system executable instructions, embodied as program modules stored in memory 16, being executed by the computer system. Generally, program modules may include routines, programs, objects, components, logic, data structures, and so on that perform particular tasks and/or implement particular input data and/or data types in accordance with the present invention (see e.g., FIG. 1).

The components of the computer system may include, but are not limited to, one or more processors or processing units 12, a memory 16, and a bus 14 that operably couples various system components, including memory 16 to processor 12. In some embodiments, the processor 12 may execute one or more modules 10 that are loaded from memory 16, where the program module(s) embody software (program instructions) that cause the processor to perform one or more method embodiments of the present invention. In some embodiments, module 10 may be programmed into the integrated circuits of the processor 12, loaded from memory 16, storage device 18, network 24 and/or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system may include a variety of computer system readable media. Such media may be any available media that is accessible by computer system, and it may include both volatile and non-volatile media, removable and non-removable media.

Memory 16 (sometimes referred to as system memory) can include computer readable media in the form of volatile memory, such as random access memory (RAM), cache memory an/or other forms. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system may also communicate with one or more external devices 26 such as a keyboard, a pointing device, a display 28, etc.; one or more devices that enable a user to interact with the computer system; and/or any devices (e.g., network card, modem, etc.) that enable the computer system to communicate with one or more other computing devices. Such communication can occur via Input/Output (I/O) interfaces 20.

Still yet, the computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with the computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1.-10. (canceled)

11. A system to automatically predict an adverse drug reaction for a drug comprising:
at least one memory storage device; and
one or more hardware processors operatively connected to the at least one memory storage device, the one or more hardware processors configured to:
receive data associated with a structure of a drug;
compute, for the drug, a plurality of drug-target interaction features, each of the drug-target interaction feature being between the drug structure and each of a plurality of unique, high-resolution target protein structures;
run one or more classifier models associated with a corresponding one or more known adverse drug reaction (ADR);
predict, using the one or more classifier models, one or more ADRs based on the drug-target interaction features involving the drug and the one or more known ADRs; and
generate an output indicating the predicted one or more ADRs.

12. The system according to claim 11, wherein to compute the plurality of drug-target interaction features, the one or more hardware processors are further configured to:
generate a molecular docking score associated with a binding potential between the drug structure and the target proteins; and
rank, for the drug, the target proteins based on the computed docking scores.

13. The system according to claim 12, wherein the received data regarding a drug structure is a 2-dimensional (2D) representation of a drug molecule, the one or more hardware processors are further configured to:
convert the 2-D drug molecule representation to a 3-dimensional (3D) representation of the drug molecule structure, wherein each of the drug-target interaction features is between the 3-D drug structure and binding receptors of each of the plurality of unique, high-resolution target protein structures.

14. The system according to claim 13, wherein the one or more hardware processors are further configured to determine an underlying cause of a predicted ADR by:
identifying a top ranked target protein structure, the top ranked target protein structure involved in a cell expression or a cell differentiation; and
determining whether the cell expression or cell differentiation involving the target protein structure is related to the predicted ADR associated with that target protein structure.

15. The system according to claim 13, wherein the one or more hardware processors are further configured to:
train a logistic regression classifier model corresponding to each of the one or more known ADRs to predict a corresponding ADR based on each of the drug-target interaction features and a corresponding known drug-ADR relationship.

16. The system according to claim 15, wherein to train the logistic regression classifier model, the one or more hardware processors are further configured to:
receive data regarding structures of each of a plurality of drugs;
receive data regarding a structure of each of the plurality of protein targets;
obtain a plurality of drug-target features comprising molecular binding scores between each of the plurality of drugs and the plurality of targets;
obtain data comprising a list of the one or more known ADRs and a corresponding known ADR-drug relationship; and
implement a machine learning technique to train the logistic regression classifier model to predict an ADR based on the molecular binding scores and the known ADR- drug relationships.

17. The system according to claim 16, wherein to train the logistic regression classifier model, the one or more hardware processors are further configured to:
harvest a first feature matrix that contains data representing the drug structures as rows, proteins as columns and the molecular binding scores as features;
map relationships between each of the drug structures and an adverse drug reaction (ADR), and
determine, for each ADR, whether the drug is associated with the ADR,
classify a drug-ADR pair according to a first binary value if the drug is associated with the ADR, and otherwise classify the drug to a second binary value if the drug is not associated with the ADR;
harvest a binary label matrix that contains drugs as rows and ADRs as columns;
develop, using the first matrix and the second matrix, the logistic regression classifier model for each ADR using the molecular docking scores as features.

18. The system according to claim 15, wherein each logistic regression classifier model for a specific ADR includes a corresponding logistic regression function used to predict a confidence score that a drug structure is associated with a specific ADR, wherein to train the logistic regression classifier model, the one or more hardware processors are further configured to:
generate, for a corresponding logistic regression function, a set of coefficients indicating a weight contribution of a plurality of corresponding molecular docking scores associated with one or more protein targets indicated by a specific ADR prediction.

19. The system according to claim 18, wherein the one or more hardware processors are further configured to determine an underlying cause of a predicted ADR by:
obtaining, for a classifier model, an absolute value of each of the coefficients of a logistic regression function indicating the weight contribution; and
identifying a largest weight contributor indicating a target protein having a largest contribution to the classifier model; and
identifying from the target protein having a largest contribution to the classifier model a type of protein mechanism relevant to the specific ADR prediction.

20. The system according to claim 13, wherein the one or more hardware processors are further configured to:
modify the drug structure to avoid interaction with a target protein underlying a cause of a predicted ADR.
